(19) United States
(12) Patent Application Publication
(10) Pub. No.: US 2014/0178326 A1
(43) Pub. Date: Jun. 26, 2014

(54) COMPOSITIONS

(71) Applicants: Thierry Audibert, Saint Leu la Foret (FR); Chinwe Bunting, Ashford Kent (GB)

(72) Inventors: Thierry Audibert, Saint Leu la Foret (FR); Chinwe Bunting, Ashford Kent (GB)

(73) Assignee: GIVAUDAN S.A., Vernier (CH)

(21) Appl. No.: 13/980,684

(22) PCT Filed: Jan. 27, 2012
(86) PCT No.: PCT/EP2012/051285

§ 371 Date: Jan. 9, 2014

(30) Foreign Application Priority Data
Jan. 27, 2011 (EP) 11290049.3

(51) Int. Cl. A01N 47/28; A01N 47/12

(52) U.S. Cl. CPC A01N 47/28; A01N 47/12
USPC 424/76.8; 560/159; 562/560; 562/439

(57) ABSTRACT

The invention relates to the use of compounds that act on N-alpha acyl glutamine amino acylase enzyme expressed by coryneform bacteria to exert a malodour-counteracting effect, in a composition or article of manufacture suitable for reducing, suppressing or eliminating malodour on inanimate surfaces. The compounds, in particular, may be N-acyl glutamine derivatives.

This invention is concerned with malodour-counteracting compounds, their use in compositions and articles for reducing, suppressing or eliminating malodour impression on inanimate surfaces, such as fabrics and especially clothing, but also articles that come into contact with, or are applied to, the body and to compositions and articles containing same.

It is known that fresh sweat contains odourless precursor molecules, which are transformed into foul-smelling volatile substances by enzymes contained in Corynebacteria that colonise human skin, particularly in the human axilla region.

N-alpha acyl glutamine substrates are the principal odourless precursors contained in sweat, and they are cleaved by an enzyme, namely N-alpha acyl glutamine aminoacylase, expressed by Corynebacteria to release unpleasant-smelling fatty acids. N-alpha acyl glutamine amino acylase enzyme is described in EP1258531.

The discovery of this enzyme and its action on the odourless precursor molecules contained in sweat led investigators to examine molecules as to their ability to interfere with the activity of this enzyme, with a view to providing methods and compositions for eliminating or suppressing the formation of malodorous fatty acids. Having regard to the nature and characteristics of this enzyme, the authors of EP1258531 proposed as malodour counteracting materials certain compounds selected from zinc chelators, dithiols, N-alpha-acyl-L-glutamines or carbamates of L-glutamine.

Both WO02/092024 and WO2004/043971 describe malodour-counteracting compounds that act on the enzyme to eliminate or suppress the formation of malodour.

The malodour-counteracting compounds were proposed exclusively for use in cosmetic and personal care products such as sticks, roll-ons, pump-sprays, aerosols, deodorant soaps, powders, solutions, gels, creams, sticks, balms and lotions, for use on the human body, in particular the human axilla.

U.S. Pat. No. 5,925,339 discloses a class of glutamine derivatives as fragrance precursors for preventing human malodour. At the time of its filing, however, the N-alpha acyl glutamine amino acylase enzyme was not known and it was not known that these fragrance precursors could act on the enzyme. As for the other malodour-counteracting compounds, these precursors were proposed for use exclusively in cosmetic products destined for application to human skin.

The use of such malodour-counteracting materials might only be considered to be useful in the treatment of surfaces that have sufficient concentrations of Corynebacteria, i.e. the human skin, and particularly the axilla. However, with the effectiveness of consumer products such as fabric fresheners, consumer habits change and fabrics may be used for longer periods of time between washes or dry cleaning.

Applicant has surprisingly found that certain inanimate surfaces, in particular fabrics and more particularly clothing, can contain substantial concentrations of these bacteria as a result of having been worn or otherwise applied to or brought into contact with human bodies. Furthermore, when these surfaces are subjected to warm and humid environments, malodour, reminiscent of human malodour, can emanate from these surfaces. As such, malodour-counteracting compounds that act on the N-alpha acyl glutamine amino acylase enzyme to exert their effect are useful in suppressing or eliminating malodour in compositions or articles of manufacture used in odour control for inanimate surfaces.

Accordingly, the invention provides in a first aspect the use in compositions and articles of manufacture suitable for controlling odour on inanimate surfaces of a compound that acts on the N-alpha acyl glutamine amino acylase enzyme expressed by coryneform bacteria to exert a malodour-counteracting effect.

The invention provides in another of its aspects a composition or article of manufacture containing a compound that acts on the N-alpha acyl glutamine amino acylase enzyme expressed by coryneform bacteria to exert a malodour-counteracting effect.

The invention provides in yet another of its aspects a method of suppressing or eliminating malodour on an inanimate surface comprising the step of applying to the surface a compound that acts on the N-alpha acyl glutamine amino acylase enzyme expressed by coryneform bacteria to exert a malodour-counteracting effect.

As used herein, the term “compound(s) that act(s) on the N-alpha acyl glutamine amino acylase enzyme expressed by coryneform bacteria to exert a malodour-counteracting effect” refers to compounds that inhibit the enzyme, thereby preventing it from cleaving the odourless precursors found in sweat to produce malodorous fatty acids. The term also refers to compounds that compete with the malodorous precursor for the binding site on the enzyme. The competitive compounds exert their effect not by inhibiting the activity of the enzyme, but by being preferentially cleaved by the enzyme, and thus preventing, or substantially reducing incidence, of cleaving of the odourless precursors.

Suitable compounds are described in EP1258531, WO02092024, WO2004/043971, as well as in U.S. Pat. No. 5,925,339, which documents and all the compounds disclosed therein are incorporated herein by reference.

Preferred are those compounds that inhibit the activity of the enzyme, as opposed to those that merely compete with odourless sweat precursors for the enzyme binding site. Unlike the competitive substrates, inhibitors are not cleaved and therefore consumed as a result of their interaction with the enzyme, and as such, lower concentrations of these materials may be employed. Similarly, as competitive substrates will be consumed, they will rely on constant re-application to a fabric in order that they can exert their activity over a prolonged period of time.

N-acyl glutamine derivatives have been found to be a particularly interesting class of molecules.

Preferred N-acyl glutamine derivatives are represented by the structure

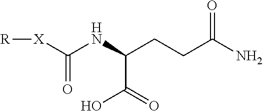

wherein X is N, O or S, and
R may be any substituent that can fit into the S₁ site of the enzyme.

The nature of R may vary widely, provided it is hydrophobic and/or bulky to fit into this site.

Preferably, it represents a linear, branched or cyclic carbon chain having about 1 to 14 carbon atoms, more particularly about 4 to 14 carbon atoms. The aforementioned chain may contain one or more heteroatoms such as O, N or S, and it may also contain unsaturation. The chain may support one or more substituents, for example amide, ester, keto, ether, amine or hydroxyl halogen, or aryl or heteroaryl substituents, which aryl or heteroaryl groups may support substituents selected from amide, ester, keto, ether, amine, halogen, alkyl or hydroxyl. The term “aryl” or “heteroaryl” as used herein is preferably a mono-cyclic or polycyclic group containing from 6 to 14 carbon atoms, and as appropriate one or more heteroatoms such as O, N or S. By way of example, any of the substituents attached to the acyl carbonyl group of the substrates mentioned above would be suitable as a group R.

More preferred groups R may be selected from a C₁₋₁₄ alkyl or C₂₋C₁₄ alkenyl, more preferably a C₄₋₁₄alkyl or alkenyl, e.g. n-butyl or sec-butyl, or an alkyl or alkenyl group here-mentioned substituted with a phenyl group, or a phenyl group substituted with any of the substituents referred to above, e.g. a benzylic group or a phenylethyl group.

Specific examples of compounds falling under this general formula include, but are not limited to

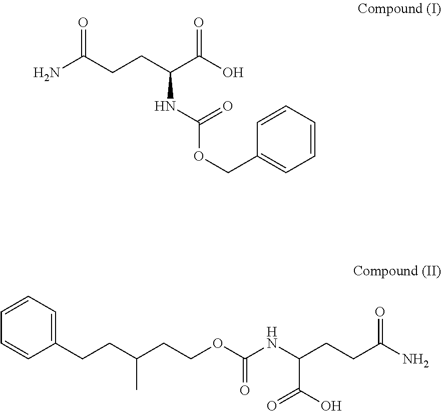

Other preferred N-acyl glutamine derivatives include compounds represented by the formula

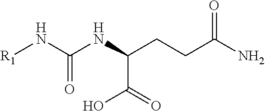

and salts thereof, wherein,
R₁ represents alkyl, aryl, alkyl-aryl or aryl-alkyl.

More particularly, R₁ represents 2-ethyl-hexyl, benzyl, 4-benzylphenyl, 3-benzylphenyl, 4-pentylphenyl, 4-butylphenyl, 4-propylphenyl, 4-isopropylphenyl, 4-ethylphenyl, 3-ethylphenyl, naphtyl, cyclooctyl, 5-phenyl-3-methyl-pentyl

Particular compounds of this general formula include

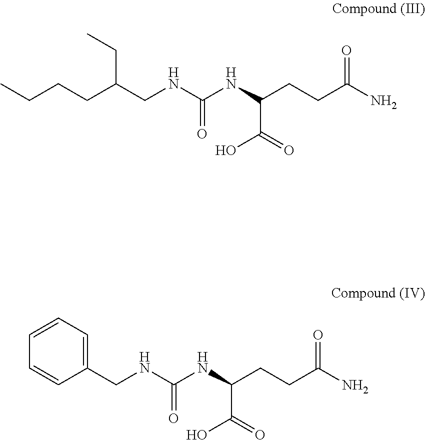

and salts thereof.

The malodour-counteracting compounds referred to herein can be incorporated into all manner of compositions or articles of manufacture that are designed to freshen, reduce, suppress or eliminate malodour on inanimate surfaces, especially fabrics, but particularly clothing or any other articles that may come into contact with, or are applied to, the body. Particularly, said compositions or articles are designed, in whole or in part, to reduce malodour on said inanimate surfaces that may be contaminated with sweat, or that may contain coryneform bacteria transferred onto said surfaces by contact with the human body, in particular the human axillae. The compositions can be employed to maintain or restore freshness by reducing malodour without the need for washing or dry cleaning.

The compositions or articles of manufacture into which the compounds may be incorporated include any such compositions or articles useful for the treatment of fabric, for purposes such as (but not limited to) cleaning, softening, refreshening, rendering antistatic, rendering easier to iron or otherwise process. Typical non-limiting examples of such compositions or articles include fabric refreshers (such as spray-on compositions and prespotters), regular and concentrated fabric softeners and conditioners in liquid, solid or aerosol form, tumble dryer sheets, solids and liquid soaps and detergent bars, NSD Bars, liquid and powder detergents, liquid and solid bleaches, and adjuvant compositions.

In a particularly preferred aspect of the invention the malodour-counteracting compounds are incorporated into compositions or articles of manufacture that are applied to (or otherwise brought into contact with, a fabric, for example, by coating, immersing or spraying.

The compositions may be in the form of liquids, preferably aqueous, more preferably clear liquids, or powders, granules or the like. An article of manufacture may be in the form of a sheet, film, absorbent article, sachet, sachet, tablet, stick, wipe and the like.

The compounds may be added to compositions in liquid form. In a further embodiment, they may also be added in a solid form. By “solid form” is mean that the compounds are adsorbed on, absorbed into or encapsulated in other substances, to give a solid material that will allow the subsequent release of the compounds. Many forms of solid formation are known to the art, and all of them may be used in the compositions of this description.

Non-limiting examples of such forms include
(a) microcapsules, in which the compound is surrounded by a shell of polymeric material. The material may be any suitable material, such as a naturally-derived material, such as gelatine, or a synthetic polymer, such as an aminoplast resin, an acrylic resin or a polyurea;
(b) particles containing hydrogenated castor oil and a fatty quaternary ammonium salt.
(c) wax particles
(d) water-insoluble or water-soluble encapsulating material, preferably a water-soluble encapsulating material, typical non-limiting examples of which include polyethylenes, polyamides, polystyrenes, polyisoprenes, polycarbonates, polyesters, polyacrylates, vinyl polymers and polyurethanes and mixtures thereof;
(e) capsules which consist of a matrix of polysaccharide and polyhydroxy compounds, water-soluble or water-dispersible encapsulating materials comprising dextrins derived from ungelatinized starch acid-esters of substituted dicarboxylic acids; useful starches including, raw starch, pregelatinized starch, modified starch derived from tubers, legumes, cereal and grains, for example corn starch, wheat starch, rice starch, waxy corn starch, oat starch, cassava starch, waxy barley, waxy rice starch, sweet rice starch, amioca, potato starch, tapioca starch, oat starch, cassava starch, and mixtures thereof; modified starches including hydrolyzed starch, acid thinned starch, starch esters of long chain hydrocarbons, starch acetates, starch octenyl succinate, and mixtures thereof.

The term “hydrolyzed starch” refers to oligosaccharide-type materials that are typically obtained by acid and/or enzymatic hydrolysis of starches, preferably corn starch. Suitable hydrolyzed starches for inclusion in the present invention include maltodextrins and corn syrup solids. The hydrolyzed starches for inclusion with the mixture of starch esters have a Dextrose Equivalent (DE) values of from about 10 to about 36 DE. The DE value is a measure of the reducing equivalence of the hydrolyzed starch referenced to dextrose and expressed as a percent (on a dry basis). The higher the DE value, the more reducing sugars present. A method for determining DE values can be found in Standard Analytical Methods of the Member Companies of Corn Industries Research Foundation, 6th ed. Corn Refineries Association, Inc. Washington, D.C. 1980, D-52.

Starch esters having a degree of substitution in the range of from about 0.01% to about 10.0% may be used to encapsulate the perfume oils of the present invention.

Modified starches having emulsifying and emulsion stabilizing capacity such as starch octenyl succinates having the ability to entrap the perfume oil droplets in the emulsion due to the hydrophobic character of the starch modifying agent. Preferably, the encapsulating material is water-soluble modified starch solid matrix, preferably a starch raw material that has been modified by treating said starch raw material with octenyl-succinic acid anhydride. More preferably the said modified starch is mixed with a polyhydroxy compound before treatment with octenyl-succinic acid anhydride.

A particular example of a modified starch is a waxy, maize starch, pregelatinised, dextrinised is mixed with sorbitol or any other alcohol type and then treated with octenyl succinic anhydride.

The use of such starches is described in European Patent 0 965 326, the contents of which are included herein by reference.

An example of such a composition in which the malodour-counteracting compounds might usefully be employed is a fabric refreshener product such as any of those products marketed under the trade mark Febreze® by the Procter & Gamble Company. An important ingredient of a Febreze® composition is cyclodextrin. This material has proven malodour-absorbing properties.

The applicant has surprisingly found that one can achieve improved malodour control when a composition such as Febreze®, is modified with the addition of a malodour-counteracting compound described herein.

Accordingly in another aspect of the invention, there is provided a composition or article for reducing, suppressing or eliminating malodour impression on inanimate surfaces comprising a malodour-counteracting compound as described herein and cyclodextrin.

The applicant has found that, whereas certain cyclodextrin molecules used as malodour-absorbing agents are useful for trapping odourants that are already lingering on inanimate surfaces, the malodour-counteracting compounds described herein are useful in suppressing odours that begin to emanate from said inanimate surfaces when they are worn, applied to, or come into contact with the human body for any prolonged period of time, particularly when that inanimate surface is subject to warm and humid conditions as a result of being worn, applied to or coming into contact with the human body.

Compositions for use in malodour suppression containing cyclodextrin are known and described in the literature. A typical example of such composition is described in WO 01/88076, which is hereby incorporated by reference.

The cyclodextrin molecules employed in such compositions may be selected from any of the known cyclodextrins that have been described for use in, or have been employed in personal care or fabric care compositions, or compositions, e.g. deodorising compositions intended to be applied to articles worn on or applied to the body, for example by means of a spray or via a dryer sheet.

They include unsubstituted cyclodextrins containing from about six to about twelve glucose units, especially alpha-cyclodextrin, beta-cyclodextrin, gamma-cyclodextrin and/or their derivatives and/or mixtures thereof. They include cyclodextrins selected from the group consisting of beta-cyclodextrin, hydroxypropyl alpha-cyclodextrin, hydroxypropyl beta-cyclodextrin, methylated-alpha-cyclodextrin, methylated-beta-cyclodextrin, and mixtures thereof.

Typically, they will be included within compositions of articles from at least about 0.1%, from at least about 1%, from at least about 2%, or from at least about 3% to about 25%, to about 20%, to about 15% or to about 10%, by weight of the composition or article.

Preferably, compositions or articles of the present invention will contain functionally-available cyclodextrins. A functionally-available cyclodextrin is a cyclodextrin that is capable of complexing with unwanted molecules that are present on the surfaces being treated with the present compositions, in this case, in particular, malodorous molecules emanating from environmental contaminants. When the surfaces are treated with the present compositions, the functionally-available cyclodextrin complexes with the unwanted molecules, thereby removing and/or reducing the presence of the unwanted molecules on the treated surfaces.

Surfaces, especially household surfaces such as fabrics, in particular clothing, countertops, and the like, often contain unwanted molecules, such as malodorous molecules. Cyclodextrin molecules are capable of capturing unwanted molecules from surfaces; however, cyclodextrin compositions used to treat surfaces containing unwanted molecules must have cyclodextrin that is available to complex with the unwanted molecules in order to capture and remove the unwanted molecules from the surface being treated. Compositions have been disclosed that are useful for controlling malodour on surfaces, wherein the compositions comprise uncomplexed cyclodextrin, i.e. cyclodextrin that does not bind with other components of the composition and therefore has free binding sites to receive malodorous molecules. For example, U.S. Pat. No. 5,942,217 issued Aug. 24, 1999 to Trinh et al. teaches compositions for controlling malodour on surfaces wherein the compositions can comprise uncomplexed cyclodextrin and materials that are cyclodextrin-compatible, such as cyclodextrin-compatible surfactants and cyclodextrin compatible perfume ingredients.

Preferred cyclodextrins include any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in a donut-shaped ring.

Non-derivatised (normal) beta-cyclodextrin can be used although it is not preferred in aqueous compositions due to its low solubility. When non-derivatised beta-cyclodextrin is used, the aqueous solution becomes cloudy and is not clear, as preferred by the present invention.

Preferably, the cyclodextrins used in the present invention are highly water-soluble such as, alpha-cyclodextrin and derivatives thereof, gamma-cyclodextrin and derivatives thereof, derivatised beta-cyclodextrins, and/or mixtures thereof. The derivatives of cyclodextrin molecules wherein some of the OH groups are converted to OR groups. Cyclodextrin derivatives include, e.g., those with short chain alkyl groups such methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH2—CH (OH)—CH3 or a —CH2CH2—OH group; branched cyclodextrins such as maltose-bonded cyclodextrins; cationic cyclodextrins such as those containing 2-hydroxy-3(dimethylamino)propyl ether, wherein R is CH2—CH(OH)—CH2—N(CH3)2 which is cationic at low pH; quaternary ammonium, e.g., 2-hydroxy-3-(trimethylammonio)propyl ether chloride groups, wherein R is CH2—CH(OH)—CH2—N⁺(CH3)3CL⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49, herein incorporated by reference; and mixtures thereof. Other cyclodextrin derivatives are disclosed in U.S. Pat. Nos. 3,426,011, Parmerter et al, issued Feb. 4, 1969; 3,453,257; 3,453,258; 3,453,259; and 3,453,260, all in the names of Parmerter et al., and all issued Jul. 1, 1969; 3,459,731, Gramera et al., issued Aug. 5, 1969; 3,553,191, Parmerter et al, issued Jan. 5, 1971; 3,565,887, Parmerter et al, issued Feb. 23, 1971; 4,535,152, Szejtli et al, issued Aug. 13, 1985; 4,616,008, Hirai et al, issued Oct. 7, 1986; 4,678,598, Ogino et al, issued Jul. 7, 1987; 4,638,058, Brandt et al., issued Jan. 20, 1987; and 4,746,734, Tsuchiyama et al, issued May 24, 1988; all of said patents being incorporated herein by reference.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-[beta]-cyclodextrin, commonly known as DIMEB, in which each glucose unit has about 2 methyl groups with a degree of substitution of about 14. A preferred, more commercially available methylated beta-cyclodextrin is a randomly methylated beta-cyclodextrin having a degree of substitution of about 12.6. The preferred cyclodextrins are available, e.g., from American Maize-Products Company and Wacker Chemicals (USA), Inc.

It is also preferable to use a mixture of cyclodextrins. Such mixtures can complex with a wider range of perfume molecules having a wider range of molecular sizes. Preferably at least a portion of the cyclodextrins is alpha-cyclodextrin and its derivatives thereof, gamma-cyclodextrin and its derivatives thereof, and/or derivatised beta-cyclodextrin, and mixtures thereof.

It is preferable that the compositions or articles of the present invention contain low levels of cyclodextrin so that a visible stain does not appear on a treated surface at normal usage levels.

Typical levels of cyclodextrin are from about 0.1% to about 5%, preferably from about 0.2% to about 4%, more preferably from about 0.3% to about 3%, most preferably from about 0.4% to about 2%, by weight of the composition.

Compositions or articles according to the invention may contain perfume ingredients. They may be employed for their hedonic effect, or they may be employed as maskers of malodorous molecules. Preferably, the perfume ingredients are compatible with the cyclodextrin, that is, they are not complexed and bound to the cyclodextrin, or not appreciably so such that the cyclodextrin is unable to absorbed malodorous molecules.

The fragrance ingredients may be selected for their odor characteristics, which are preferred in order to provide a fresh impression on the surface to which the composition is directed, preferably those which provide a fresh impression for fabrics, more particularly clothes.

Fragrance ingredients may be selected from the group consisting of aromatic and aliphatic esters having molecular weights from about 130 to about 250; aliphatic and aromatic alcohols having molecular weights from about 90 to about 240; aliphatic ketones having molecular weights from about 150 to about 260; aromatic ketones having molecular weights from about 150 to about 270; aromatic and aliphatic lactones having molecular weights from about 130 to about 290; aliphatic aldehydes having molecular weights from about 140 to about 200; aromatic aldehydes having molecular weights from about 90 to about 230; aliphatic and aromatic ethers having molecular weights from about 150 to about 270; and condensation products of aldehydes and amines having molecular weights from about 180 to about 320; and essentially free from nitromusks and halogenated fragrance materials.

Representative fragrance ingredients include:
adoxal aliphatic aldehyde 2,6,10-trimethyl-9-undecen-1-al, allyl amyl glycolate, allyl amyl glycolate, allyl cyclohexane propionate, allyl-3-cyclohexyl propionate, amyl acetate, 3-methyl-1-butanol acetate, amyl salicylate, amyl salicylate, anisic aldehyde, 4-methoxy benzaldehyde, aurantiol, bacdanol, 2-ethyl-4-(2,2,3-trimethyl-3-cyclopenten-1-yl)-2-buten-1-ol, benzaldehyde, benzophenone, benzophenone, benzyl acetate, benzyl acetate, benzyl salicylate, benzyl salicylate, beta damascene, 1-(2,6,6-trimethyl-1-cyclo-hexen-1-yl)-2-buten-1-one, beta gamma hexanol, 3-hexen-1-ol, buccoxime, 1,5-dimethyl-oxime bicyclo[3,2,1]octan-8-one, cedrol, octahydro-3,6,8,8-tetramethyl-1H-3A,7-methanoazulen-6-ol, cetalox, dodecahydro-3A,6,6,9A-tetramethylnaphtho[2,1B]-furan, cis-3-hexenyl acetate, cis-3-hexenyl acetate, cis-3-hexenyl salicylate, beta, gamma-hexenyl salicylate, citronellol, 3,7-dimethyl-6-octenol, citronellyl nitrile, geranyl nitrile, clove stem oil, coumarin, cyclohexyl salicylate, cyclohexyl salicylate, cymal, 2-methyl-3-(para iso propylphenyl)propionaldehyde, decyl aldehyde, decyl aldehyde, delta damascene, 1-(2,6,6-trimethyl-3-cyclo-hexen-1-yl)-2-buten-1-one, dihydromyrcenol, 3-methylene-7-methyl octan-7-ol, dimethyl benzyl carbinyl ester, dimethyl benzyl carbinyl acetate, ethyl vanillin, ethyl-2-methyl butyrate, ethyl-2-methyl butyrate, ethylene brassylate, ethylene tridecan-1,13-dioate, eucalyptol, 1,8-epoxy-para-menthane, eugenol alcohol 4-allyl-2-methoxy phenol, exaltolide, cyclopentadecanolide, flor acetate, dihydro-nor-yclopentadienyl acetate, florhydral, 3-(3-isopropylphenyl) butanal, frutene, dihydro-nor-yclopentadienyl propionate, galaxolide, 1,3,4,6,7,8-hexahydro-4,6,6,7,8,8-hexamethylcyclopenta-gamma-2-benzopyrane, gamma decalactone, 4-N-hepty-4-hydroxybutanoic acid, gamma dodecalactone, 4-N-octyl-4-hydroxy-butanoic acid, geraniol, 3,7-dimethyl-2,6-octadien-1-ol, geranyl acetate, 3,7-dimethyl-2,6-octadien-1-yl acetate, geranyl nitrile, 3,7-diemthyl-2,6-octadienenitrile, helional, alpha-methyl-3,4,(methylenedioxy) hydrocinnamaldehyde, heliotropin, heliotropin hexyl acetate, hexyl acteate, hexyl cinnamic aldehyde, alpha-n-hexyl cinnamic aldehyde, hexyl salicylate, hexyl salicylate, hydroxyambran, 2-cyclododecyl-propanol, hydroxycitronellal, hydroxycitronellal, ionone alpha, 4-(2,6,6-trimethyl-1-cyclohexenyl-1-yl)-3-buten-2-one, ionone beta aliphatic ketone 4-(2,6,6-trimethyl-1-cyclohexen-1-yl)-3-butene-2-one, ionone gamma methyl 4-(2,6,6-trimethyl-2-cyclohexyl-1-yl)-3-methyl-3-buten-2-one, iso E super 7-acetyl-1,2,3,4,5,6,7,8-octahydro-1,1,6,7,tetramethyl naphthalene, iso eugenol ether 2-methoxy-4-(1-propenyl) phenol, iso jasmone aliphatic ketone 2-methyl-3-(2-pentenyl)-2-cyclopenten-1-one, koavone, acetyl di-isoamylene, lauric aldehyde, lavandin natural, lavender natural, lemon CP, d-limonene, d-limonene/orange terpenes alkene 1-methyl-4-iso-propenyl-1-cyclohexene, linalool, 3-hydroxy-3,7-dimethyl-1,6-octadiene, linalyl acetate ester 3-hydroxy-3,7-dimethyl-1,6 octadiene acetate, 2,4-dihydroxy-3,6-dimethyl benzoic acid methyl ester, lyral, 4-(4-hydroxy-4-methyl-pentyl) 3-cylcohexene-1-carboxaldehyde, majantol, 2,2-dimethyl-3-(3-methylphenyl)-propanol, mayol, 4-(1-methylethyl) cyclohexane methanol, methyl anthranilate, methyl-2-aminobenzoate, methyl beta naphthyl ketone, methyl beta naphthyl ketone, methyl cedrylone, methyl cedrenyl ketone, methyl chavicol, 1-methyloxy-4,2-propen-1-yl benzene, methyl dihydro jasmonate, methyl dihydrojasmonate, methyl nonyl acetaldehyde, methyl nonyl acetaldehyde, musk indanone, 4-acetyl-6-tert butyl-1,1-dimethyl indane, nerol, 2-cis-3,7-dimethyl-2,6-octadien-1-ol, nonalactone, 4-hydroxynonanoic acid, norlimbanol, 1-(2,2,6-trimethyl-cyclohexyl)-3-hexanol, orange CP, P.T. bucinal, 2-methyl-3(para tert butylphenyl)propionaldehyde, para hydroxy phenyl butanone, para hydroxy phenyl butanone patchouli, phenyl acetaldehyde, 1-oxo-2-phenylethane phenyl acetaldehyde dimethyl, phenyl acetaldehyde dimethyl acetal phenyl ethyl acetate, phenyl ethyl acetate phenyl ethyl alcohol, phenyl ethyl alcohol, phenyl ethyl phenyl acetate, 2-phenylethyl phenyl acetate, phenyl hexanol/phenoxanol, 3-methyl-5-phenylpentanol, polysantol, 3,3-dimethyl-5-(2,2,3-trimethyl-3-cyclopenten-1-yl)-4-penten-2-ol, prenyl acetate, 2-methylbuten-2-ol-4-acetate, rosaphen, 2-methyl-5-phenyl pentanol, sandalwood, alpha-terpinene aliphatic alkane 1-methyl-4-iso-propylcyclohexadiene-1,3-terpineol (alpha terpineol and alcohol para-menth-1-en-8-ol, para-beta terpineol) menth-1-en-1-ol, terpinyl acetate ester para-menth-1-en-8-yl acetate, tetra hydro linalool, 3,7-dimethyl-3-octanol, tetrahydromyrcenol, 2,6-dimethyl-2-octanol, tonalid, 7-acetyl-1,1,3,4,4,6-hexamethyl, tetralin, undecalactone lactone 4-N-heptyl-4-hydroxybutanoic acid, undecavertol, 4-methyl-3-decen-5-ol, undecyl aldehyde , undecanal, undecylenic aldehyde, undecylenic aldehyde, vanillin aromatic aldehyde 4-hydroxy-3-methoxybenzaldehyde, verdox, 2-tert-butyl cyclohexyl acetate, vertenex, 4-tert-butyl cyclohexyl acetate and mixtures thereof.

Preferably compositions or articles contain an effective amount of perfume to provide the freshening fragrance to surfaces when first applied and some lingering fragrance in-wear.

Compositions according to the invention may contain an adjuvant such as a solubilising aid to the solubilisation of any ingredient such as perfume ingredients, but also any other ingredients, including the malodour-counteracting compounds.

A suitable solubilising aid is surfactant, preferably no-foaming or low-foaming surfactant. Suitable surfactants are nonionic surfactants, anionic surfactants, cationic surfactants, amphoteric surfactants, zwitterionic surfactants, and mixtures thereof, preferably nonionic surfactants and cationic surfactants, and mixtures thereof. Suitable solvents and diluents may be selected from compounds well known to the fragrance art for such purposes, typical non-limiting examples including propylene glycol, dipropylene glycol, isopropyl myristate, and the like.

When the solubilising agent is present, it is typically present at a level of from about 0.02% to about 3%, by weight of the composition.

Aqueous solutions are preferred in the present invention for the reduction of malodour impression. The preferred aqueous carrier of the present invention is water. The water which is used can be distilled, deionized, or tap water. Water containing a small amount of low molecular weight monohydric alcohols, e.g., ethanol, methanol, and isopropanol, or polyols, such as ethylene glycol and propylene glycol, can also be useful.

Compositions according to the invention may contain other adjuvants such as preservatives, pH control agents (such as buffers), chelating agents, defoaming agents, antifoaming agents, antistatic agents, colorants, antioxidants, aesthetic agents such as opacifiers, perlizers, silicones derivatives, dyes and mixtures thereof.

There now follows a series of non-limiting examples that serve to illustrate the invention.

### EXAMPLE 1

The objective of the study is to measure the effectiveness of malodour-counteracting compounds for use in the present invention at reducing malodour generated on cloth in the presence of the enzyme N-alpha acyl glutamine aminoacylase, and the sweat precursor for the malodorous fatty acid 3-methyl-3-hydroxy-hexanoic acid (HMHA). The aim is to achieve a significant reduction in malodour on cloth against:
a) an untreated fabric
b) a marketed fabric freshener, namely Spring & Renewal Febreze®.

### Method:

### Generating Malodour—the Control:

140 μg of odourless precursor for HMHA (equivalent to 15 minutes of physical exercise) is dissolved in 125 μl of 12% ethanol/88% water and applied to 12.5 cm2 polycotton (40/60 mix) cloth in a 30 ml Beatson jar.

The cloth was allowed to dry completely in a 40° C. oven before checking for residual malodour.

Thereafter, the cloth was moistened with 125 μl of a solution containing 0.33 μg/ml of the enzyme N-α-acyl glutamine aminoacylase in 50 mM phosphate buffer pH 6 and the treated cloth was allowed to incubate in a glass jar at 37° C. for 30 minutes.

Thereafter a few drops of a 10% concentration of HCL were added to protonate the acids.

Malodour was assessed by a panel on a scale of 0 (nothing)-10 (very strong)

### Inhibiting Malodour—the Test Product:

Malodour precursor was applied to cloth as described above and the cloth allowed to dry in an oven at 40° C.

125 μl of each of the following solutions was applied on to polycotton cloth already containing the precursor and allowed to dry in a 40° C. oven:

0.1% of the Compounds (I), (II), and (III) defined above (hereinafter referred to generally as “compound”), dissolved in an un-fragranced in-house fabric refresher base 0.1% of each compound dissolved in a fragranced fabric refresher base fragranced with a 0.05% of a proprietary fragrance having a floral-green-aldehyde odour (hereinafter “fragrance”).

0.1% of each inhibitor dissolved in a Febreze(r) Market product (Spring & Renewal)

### Fragranced Non-Active Base

The composition of the fabric refresher base is as follows.

| | % Range | | |
|---|---|---|---|
| Ingredients | Compound I | compound II | Compound III |
| Water | To 100 | To 100 | To 100 |
| Ethanol | 5.00 | 5.00 | 5.00 |
| compound | 0.10 | 0.10 | 0.10 |
| Tween ™ 20 surfactant | 0.10 | 0.10 | 0.50 |
| Fragrance | 0.05 | 0.05 | 0.05 |

Once the samples were dry, they were moistened with 125 μl of a solution containing 0.33 μg/ml of the enzyme N-α-acyl glutamine aminoacylase in 50 mM phosphate buffer pH 6 and allowed to incubate in a glass jar at 37° C. for 30 mins. Thereafter, a few drops of a 10% concentration of HCL were added to protonate the acids

Malodour was assessed by a panel on a scale of 0 (nothing)-10 (very strong)

An added control, which consisted of the precursor and enzyme diluents as well as the HCL was used to understand their contribution to the overall malodour profile. These were dosed directly onto cloth.

An untreated control was prepared for comparison as described above.

At 0.1%, all three Compounds (I) (II) and (III) proved soluble in a cyclodextrin-containing fabric refreshener

The results from the studies were the following:

All of the malodour counteracting Compounds (I, II and III), in their respective test products showed a clear and significant malodour reduction compared with the control.

Combining each of the compounds with the market product (Febreze) showed a significant reduction in malodour compared to the control and also to the market product alone.

1. A method for reducing, suppressing or eliminating malodour on inanimate surfaces, comprising incorporating in a composition or article of manufacture, a compound that acts on N alpha acyl glutamine amino acylase enzyme expressed by coryneform bacteria to exert a malodour-counteracting effect.

2. The method according to claim 1 wherein the compound is an N-acyl glutamine derivative.

3. The method according to claim 2 wherein the N-acyl glutamine derivatives are represented by the structure 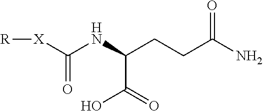
wherein X is N, O or S, and
R is any substituent that can fit into the S₁ site of the enzyme.

4. The method according to claim 3 wherein R is selected from a C₁₋₄ alkyl or a C₂-C₁₄ alkenyl, or the C₁₋₁₄ alkyl or the C₂-C₁₄ alkenyl group substituted with a phenyl group, or a phenyl group substituted with a C₁₋₁₄ alkyl, a C₂-C₁₄ alkenyl or a phenyl group.

5. The method according to claim 2 wherein the compounds are N-acyl glutamine derivatives represented by the formula 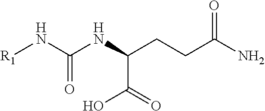
and salts thereof, wherein R₁ represents alkyl, aryl, alkyl-aryl or aryl-alkyl.

6. The method according to claim 1 wherein the compounds are selected from the group consisting of 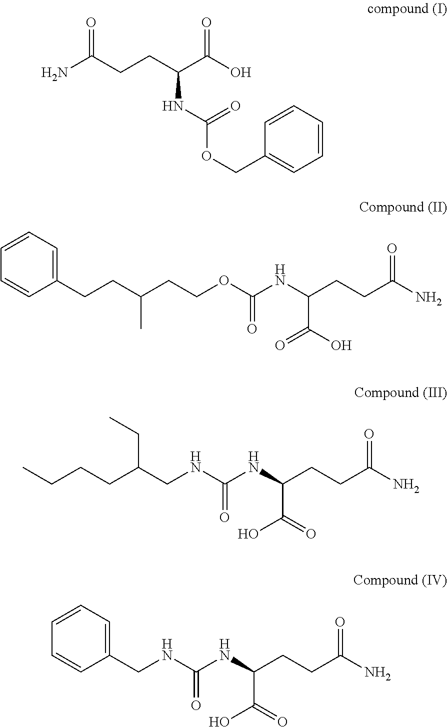 [SMILES: NC(=O)CC[C@H](NC(=O)OCc1ccccc1)C(=O)O ; CC(CCOC(=O)NC(CCC(N)=O)C(=O)O)CCc1ccccc1 ; CCCCC(CC)CNC(=O)N[C@@H](CCC(N)=O)C(=O)O ; NC(=O)CC[C@H](NC(=O)NCc1ccccc1)C(=O)O]
and salts thereof.

7. A composition or article of manufacture adapted to freshen, or reduce, suppress or eliminate malodour on inanimate surfaces comprising a compound that acts on N alpha acyl glutamine amino acylase enzyme expressed by coryneform bacteria to exert a malodour-counteracting effect.

8. The composition or article of manufacture according to claim 7 in the form of a liquid composition.

9. The composition according to claim 8, in which the composition is aqueous.

10. The composition or article of manufacture according to claim 7 in the form a fabric freshener, a fabric softener or a detergent.

11. The composition or article of manufacture according to claim 7 comprising a cyclodextrin and optionally other adjuvants.

12. The composition according to claim 7 wherein the compound is an N-acyl glutamine derivative.

13. The composition according to claim 12 wherein the N-acyl glutamine derivatives are represented by the structure 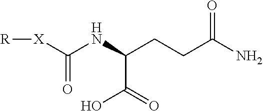
wherein X is N, O or S, and R is any substituent that can fit into the S₁ site of the enzyme.

14. The composition according to claim 13 wherein R is selected from a C₁₋₁₄ alkyl or a C₂-C₁₄ alkenyl group; or the C₁₋₁₄ alkyl or the C₂-C₁₄ alkenyl group substituted with a phenyl group; or a phenyl group substituted with a C₁₋₁₄ alkyl, a C₂-C₁₄ alkenyl or a phenyl group.

15. The composition according to claim 13 wherein R is selected from a C₄₋₁₄ or a C₄₋₁₄ alkenyl group, n-butyl or sec-butyl; or the C₄₋₁₄ alkyl or the C₄₋₁₄ alkenyl group substituted with a phenyl group; or a phenyl group substituted with a C₄₋₁₄ alkyl, a C₄₋₁₄ alkenyl or a phenyl group; or a benzylic group; or a phenylethyl group.

16. The composition according to claim 7 wherein the compounds are N-acyl glutamine derivatives represented by the formula 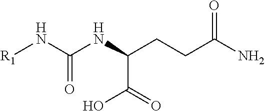
and salts thereof, wherein R₁ represents alkyl, aryl, alkyl-aryl or aryl-alkyl.

17. The composition according to claim 7 wherein the compounds are selected from the group consisting of 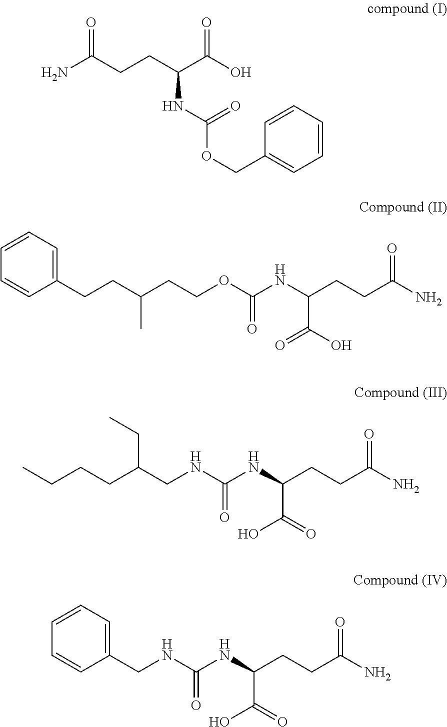 [SMILES: NC(=O)CC[C@H](NC(=O)OCc1ccccc1)C(=O)O ; CC(CCOC(=O)NC(CCC(N)=O)C(=O)O)CCc1ccccc1 ; CCCCC(CC)CNC(=O)N[C@@H](CCC(N)=O)C(=O)O ; NC(=O)CC[C@H](NC(=O)NCc1ccccc1)C(=O)O]
and salts thereof.

18. The method according to claim 3 wherein R is selected from a C₄₋₁₄ alkyl or a C₄₋₁₄ alkenyl group, n-butyl or sec-butyl; or the C₄₋₁₄ alkyl or the C₄₋₁₄ alkenyl group substituted with a phenyl group or a phenyl group substituted with a C₄₋₁₄ alkyl, a C₄₋₁₄ or phenyl group; or a benzylic group; or a phenylethyl group.

19. The method according to claim 1, wherein the composition or article of manufacture is adapted to be applied to or brought into contact with the inanimate surfaces.
